(19) United States
(12) Patent Application Publication
(10) Pub. No.: US 2013/0166092 A1
(43) Pub. Date: Jun. 27, 2013

(54) SYSTEM AND MTEHOD FOR MONITORING SERVER SIMULATED LOADS

(71) Applicant: KANG-BIN WANG, Shenzhen City (CN)

(72) Inventor: KANG-BIN WANG, Shenzhen City (CN)

(73) Assignees: HON HAI PRECISION INDUSTRY CO., LTD., Tu- Cheng (TW); HONG FU JIN PRECISION INDUSTRY (ShenZhen) CO., LTD., Shenzhen City (CN)

(21) Appl. No.: 13/596,160

(22) Filed: Aug. 28, 2012

(30) Foreign Application Priority Data
Dec. 22, 2011 (CN) 201110435053.2

(51) Int. Cl. G05D 23/00

(52) U.S. Cl. 700/299

(57) ABSTRACT

A system for monitoring server simulated loads includes a fan, a switch module, a server chassis, a temperature sensor, and a micro control unit (MCU). The load module includes a plurality of heating loads. The switch module includes a plurality of switches, each of which is connected to one of the plurality of heating loads. The fan, the load module, and the switch module are housed in the server chassis. The temperature sensor detects an interior temperature of the server chassis. The MCU controls the switch module to turn on/off one or more loads of the plurality of heating loads, and/or adjusts a rotation speed of the fan, and determines whether the interior temperature exceeds a predetermined threshold. A method for monitoring server simulated loads is also disclosed.

### REFERENCE TO RELATED APPLICATIONS

This application claims all benefits accruing under 35 U.S.C. § 119 from China Patent Application No. 201110435053.2, filed on Dec. 22, 2011 in the State Intellectual Property Office of China, the contents of the China Application are hereby incorporated by reference.

### BACKGROUND

1. Technical Field

The disclosure generally relates to monitoring systems and methods, and particularly relates to systems and methods for monitoring server simulated loads.

2. Description of Related Art

To plan out a thermal design for a series of servers, an optimal thermal solution is determined based upon repeatedly monitoring server simulated loads. Then the optimal thermal solution can be applied to the series of servers.

Conventional systems and methods for monitoring server simulated loads often utilizes a server simulated load chassis, in which a plurality of heating loads, a plurality of fans, and a temperature sensor are housed. Each of the heating loads may be turned on/off by a switch. The greater the number of the heating loads being turned on, the more heat the heating loads will generate. Adjusting the rotation speed of the fans and/or replacing different heat sinks can be performed to keep the internal temperature of the server simulated load chassis within a safe range. However, it is inconvenient and time-consuming to manually operate the switches of the plurality of heating loads.

Therefore, there is a need to provide a high-efficiency and more accurate system and method for monitoring server simulated loads.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a system for monitoring server simulated loads according to one embodiment.

FIG. 2 is a block diagram of a switch module and a load module of the system of FIG. 1.

FIGS. 3A and 3B show a flowchart illustrating one embodiment of a method for monitoring server simulated loads.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language, such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

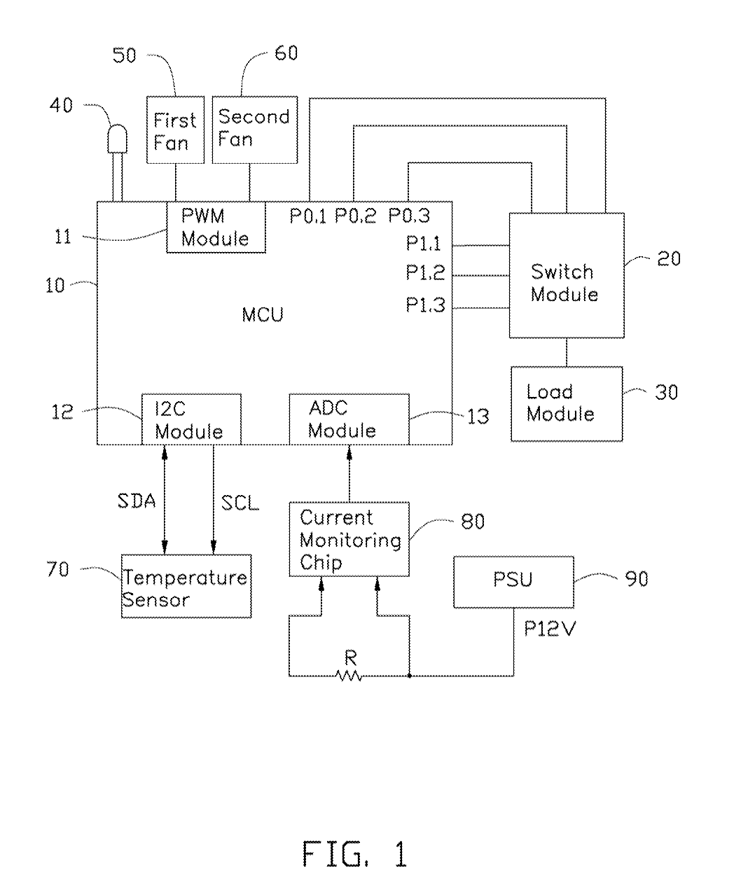

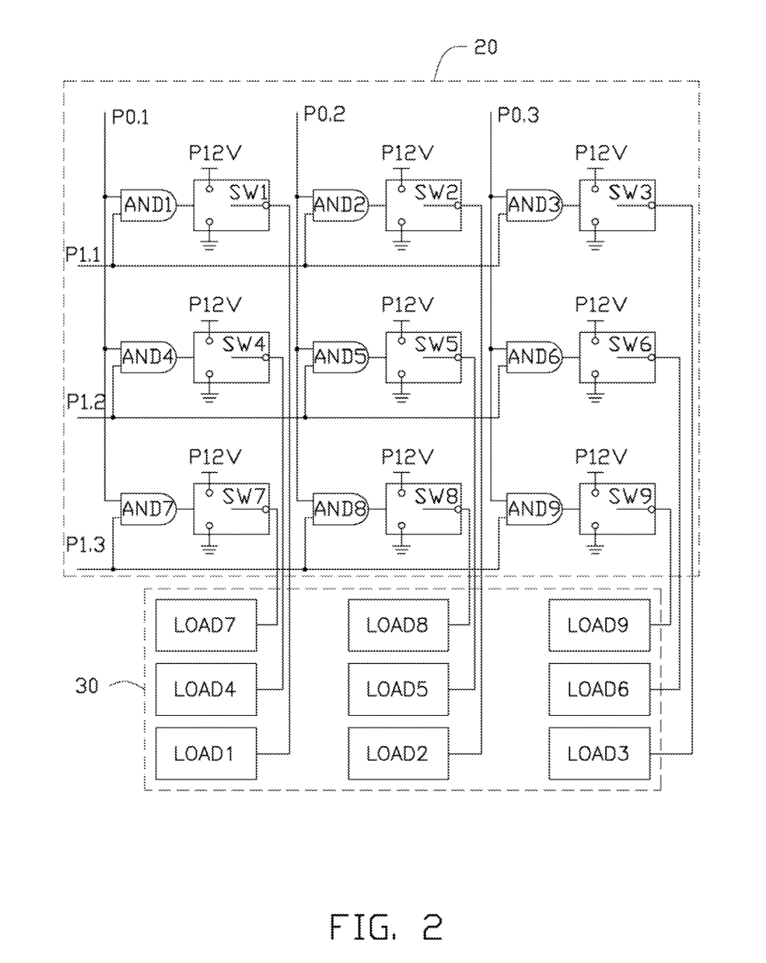

FIG. 1 shows a system for monitoring server simulated loads according to one embodiment. The system includes a micro control unit (MCU) 10, a switch module 20, a load module 30, and an alarm lamp 40. The switch module 20 is connected to the MCU 10. The load module 30 is connected to the switch module 20. The alarm lamp 40 is connected to the MCU 10. In some embodiments, the MCU 10 is an 8051 single chip microcontroller (SCM), which includes ports P0.1, P0.2, P0.3, P1.1, P1.2, and P1.3. The ports P0.1-P0.3 and P1.1-P1.3 are connected to the switch module 20. In one embodiment, the switch module 20 includes nine switches SW1 to SW 9 and the load module 30 includes nine loads LOAD1 to LOAD9 as shown in FIG. 2. The MCU 10 may output control signals to the switch module 20 via the ports P0.1-P0.3 and P1.1-P1.3 to control the plurality of switches SW1 to SW9.

The MCU 10 includes a pulse width modulation (PWM) module 11, an inter-integrated circuit (I2C) module 12, and an analog-to-digital conversion (ADC) module 13. The PWM module 11 is connected to each of a first fan 50 and a second fan 60. The PWM module 11 may output PWM signals to the first fan 50 and to the second fan 60 to adjust the rotation speed. The I2C module 12 is connected to a temperature sensor 70 via a serial data (SDA) line and a serial clock (SCL) line. The I2C module 12 may send a signal reading instruction to the temperature sensor 70 via the SDA line. The temperature sensor 70 may return temperature information to the I2C module via the SDA line in response to the signal reading instruction. The I2C module 12 may send a clock signal to the temperature sensor 70 via the SCL line and send control signals to the temperature sensor 70 at a frequency based on the clock signal.

The MCU 10 is connected with a current monitoring chip 80 and a power supply unit (PSU) 90. The PSU 90 may output multi-path direct current (DC) voltages, such as 12V and 5V, to power various electronic components or devices of the system. The PSU 90 includes a power line P12V connected to a power resistor R. The current monitoring chip 80 is connected to two ends of the power resistor R. In an example, the rated power of the power resistor R is 3 watts (W), the resistance of the power resistor R is 0.001 ohms (Ω). The current monitoring chip 80 may calculate the current flowing through the power resistor R according to a voltage difference between the two ends of the power resistor R and the resistance of the power resistor R. The current flowing through the power line P12V is substantially equal to that flowing through the power resistor R.

The ADC module 13 is connected to an output port of the current monitoring chip 80. The current monitoring chip 80 may transmit the measured current to the ADC module 13 via the output port of the current monitoring chip 80. The ADC module 13 may convert the measured current to a digital signal to obtain a current value. The MCU 10 may multiply the current value by the output voltage (e.g., 12V) to obtain an output power of the power line P12V.

Referring to FIG. 2, the switch module 20 includes nine AND gates, AND1 to AND9, arranged in a matrix. Each of the nine AND gates AND1 to AND 9 includes an output port connected to one of the nine switches SW1 to SW9. Each of the nine AND gates AND 1 to AND 9 includes a first input port and a second input port. In the first row of the matrix, the first input ports of the AND gates AND1, AND4, and AND7 are all connected to the port P0.3 of the MCU 10. In the second row of the matrix, the first input ports of the AND gates AND2, AND5, and AND8 are all connected to the port P0.2 of the MCU 10. In the third row of the matrix, the first input ports of the AND gates AND3, AND6, and AND9 are all connected to the port P0.3 of the MCU 10. In the first line of the matrix, the second input ports of the AND gates AND1, AND2, and AND3 are all connected to the port P1.1 of the MCU 10. In the second line of the matrix, the second input ports of the AND gates AND4, AND5, and AND6 are all connected to the port P1.2 of the MCU 10. In the third line of the matrix, the second input ports of the AND gates AND7, AND8, and AND9 are all connected to the port P1.3 of the MCU 10.

In some embodiments, each of the nine switches SW1 to SW9 is a Single-Pole Double-Throw (SPDT) switch. The output ports of the nine AND gates AND1 to AND9 are connected to controlling terminals of the nine switches SW1 to SW9, respectively. When one of the nine AND gates AND1 to AND9 outputs a high voltage level signal to a corresponding switch, the corresponding switch is electrically connected to the power line P12V of the PSU 90 such that the PSU 10 may output a voltage signal (e.g., 12V) to a corresponding one of the nine loads LOAD 1 to LOAD9. When one of the nine AND gates AND1 to AND9 outputs a low voltage level signal to a corresponding switch, the corresponding switch is grounded such that a zero voltage signal is output to a corresponding one of the nine loads LOAD1 to LOAD9.

The nine loads LOAD1 to LOAD9 of the load module 30 are arranged in a matrix of 3 by 3. The nine loads LOAD1 to LOAD9 are connected to the output terminals of the nine switches SW1 to SW9, respectively. When one of the nine switches SW1 to SW9 is electrically connected to the PSU 90, a corresponding one of the nine loads LOAD1 to LOAD9 is turned on and begins to generate heat. When one of the nine switches SW1 to SW9 is grounded, a corresponding one of the nine loads LOAD1 to LOAD9 is turned off and begins to cool down.

In some embodiments, the load module 30, the first fan 50, the second fan 60, and the temperature sensor 70 are housed in a server chassis (not shown). The MCU 10 and other peripheral circuits may be located inside or outside of the server chassis. It is appreciated to a person skilled in the art that an additional number of loads and/or fans can be attached to the system so as to meet various requirements.

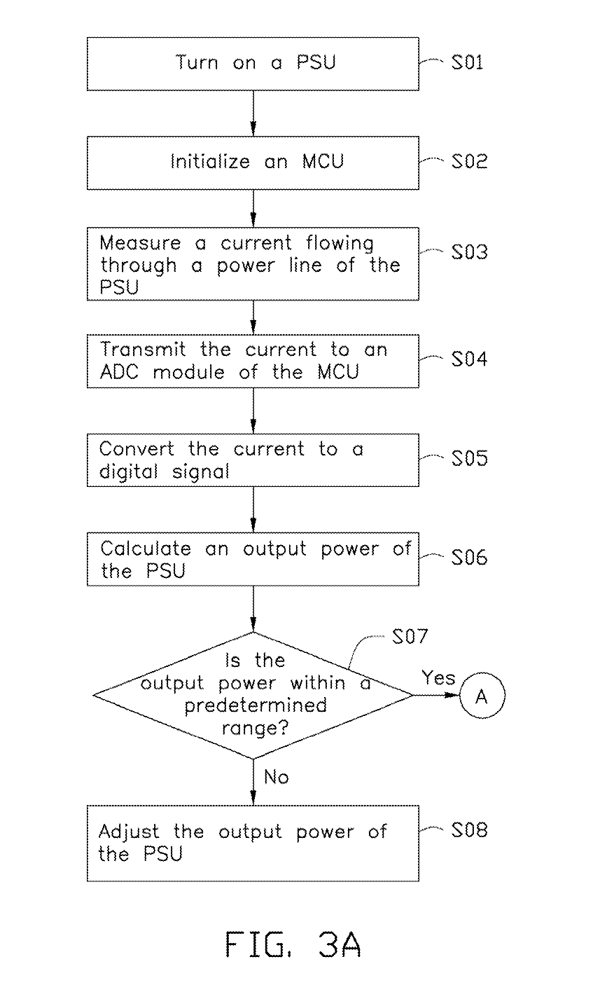

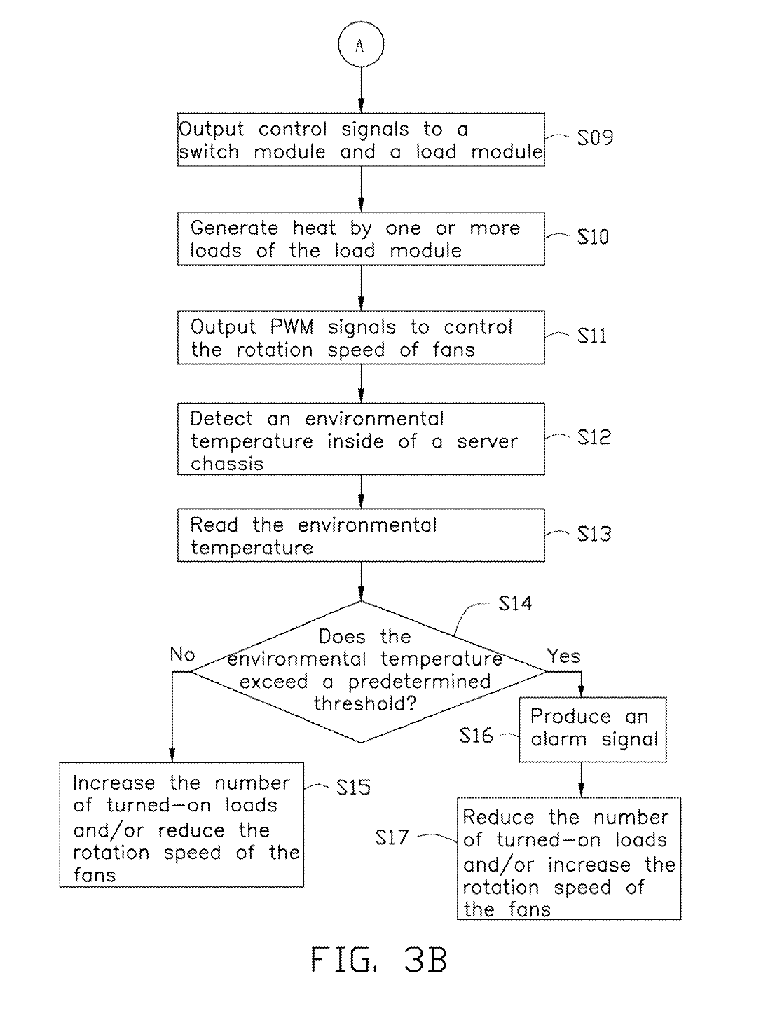

FIGS. 3A and 3B show a flowchart illustrating one embodiment of method for monitoring server simulated loads. The method comprises the following steps.

In step S01, the PSU 90 is turned on and outputs multi-path DC voltages to power the system.

In step S02, the MCU 10 is initialized.

In step S03, the current monitoring chip 80 measures a current flowing through the power line P12V of the PSU 90. In this step, the current monitoring chip 80 first detects the voltage difference between the two ends of the power resistor R, calculates a current flowing through the power resistor R according to the voltage difference and the resistance of the power resistor R. Because the current flowing through the power line P12V is substantially equal to that flowing through the power resistor R, the current monitoring chip 80 can obtain the current flowing through the power line P12V.

In step S04, the current monitoring chip 80 transmits the measured current to the ADC module 13 of the MCU 10.

In step S05, the ADC module 13 converts the measured current to a digital signal to obtain a current value.

In step S06, the MCU 10 multiplies the current value by the output voltage (e.g., 12V) to obtain an output power of the power line P12V of the PSU 90.

In step S07, the MCU 10 determines whether the output power of the power line P12V of the PSU 90 is within a predetermined range. If the output power exceeds the predetermined range, the flow goes to step S08. If the output power is within the predetermined range, the flow goes to step S09.

In step S08, the output power of the power line P12V of the PSU 90 is adjusted to be within the predetermined range.

In step S09, the ports P0.1 to P0.3 and P1.1 to P1.3 of the MCU 10 output signals to control the switch module 20 and the load module 30. In this step, the MCU 10 turns on one or more loads of the load module 30 according to set parameters. For example, logic may require the MCU 10 to turn on the load LOAD1. The port P0.1 of the MCU 10 outputs a high voltage level signal to the first input port of the AND gate AND1, and the port P1.1 of the MCU 10 outputs a high voltage level signal to the second input port of the AND gate AND 1. Thus, both of the two input ports of the AND gate AND1 receive a high voltage level signal. Accordingly, the output port of the AND gate AND1 outputs a high voltage level signal to the control port of the switch SW1 so as to control the switch SW1 to be electrically connected to the power line P12V of the PSU 90. Then the voltage signal (e.g., 12V) will be output to the load LOAD1 so as to turn on the load LOAD1. In the same way, the MCU 10 may turn on any additional loads of the load module 30. If the MCU is instructed to turn off one of the loads, the MCU outputs a low voltage level signal to the corresponding AND gate. The corresponding AND gate outputs a low voltage level signal to the corresponding switch. The corresponding switch is grounded and hence one of the loads is turned off.

In step S10, the one or more turned-on loads of the load module 30 start to generate heat.

In step S11, the PWM module 11 outputs PWM signals to control the rotation speed of the first fan 50 and the second fan 60.

In step S12, the temperature sensor 70 detects an internal temperature of the server chassis.

In step S13, the I2C module 12 of the MCU 10 reads the internal temperature detected by the temperature sensor 70.

In step S14, the MCU 10 determines whether the internal temperature of the server chassis exceeds a predetermined threshold. If so, the flow goes to step S16. If not, the flow goes to step S15.

In step S15, the MCU 10 increases the number of turned-on loads of the load module 30 and/or reduces the rotation speed of the first and the second fans 50, 60 thereby raising the internal temperature of the server chassis.

In step S16, the alarm lamp 40 produces an alarm signal to indicate that the internal temperature of the server chassis is too high.

In step S17, the MCU 10 reduces the number of turned-on loads and/or increases the rotation speed of the first and the second fans 50, 60 thereby lowering the internal temperature of the server chassis.

In some embodiments, the MCU 10 may output PWM signals to control the first and the second fans 50, 60 to rotate at a constant speed, and then gradually increase the number of turned-on loads of the load module 30 so as to determine the limit of the heat dissipation capabilities of the system. Besides, the MCU 10 may maintain a constant number of turned-on loads of the load module 30, and then adjust the rotation speed of the first and the second fans 50, 60 to measure the thermal capacity of the system. With the ability to employ those processes, an optimal thermal solution for the system can easily be determined.

Although numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn to or in relation to a method may give some indication in reference to certain steps. However, any indication given is only to be viewed for identification purposes, and is not necessarily a suggestion as to an order for the steps.

What is claimed is:

1. A system for monitoring server simulated loads, the system comprising:
a fan;
a load module comprising a plurality of loads;
a switch module comprising a plurality of switches, each of the plurality of switches is connected to each of the plurality of loads;
a server chassis housing the fan, the load module, and the switch module;
a temperature sensor adapted to detect an internal temperature of the server chassis; and
a micro control unit coupled to each of the switch module, the fan, and the temperature sensor, wherein the micro control unit is adapted to control the switch module to turn on/off one or more of the plurality of loads, to adjust a rotation speed of the fan, and to determine whether the internal temperature of the server chassis exceeds a predetermined threshold.

2. The system of claim 1, further comprising a power supply unit and a current monitoring chip, wherein the power supply unit comprises a power line outputting a voltage signal to the load module, the current monitoring chip is connected to the power line and adapted to measure a current flowing through the power line.

3. The system of claim 2, wherein the micro control unit comprises an analog-to-digital conversion (ADC) module, the current monitoring chip comprises an output port connected to the ADC module and is adapted to transmit the current measured by the current monitoring chip to the ADC module, the ADC module is adapted to convert the current measured by the current monitoring chip into a digital signal, the micro control unit is adapted to calculate an output power of the power line based on the digital signal from the ADC module.

4. The system of claim 1, further comprising an alarm lamp coupled to the micro control unit and adapted to produce an alarm signal when the internal temperature exceeds the predetermined threshold.

5. The system of claim 1, wherein the switch module further comprises a plurality of AND gates connected to the plurality of switches and an output port, each of the plurality of AND gates comprising two input ports, each of the two input ports being connected to a different output port of the micro control unit, and the output port being connected to each of the plurality of switches; each of the plurality of switches comprises an output port connected to each of the plurality of loads.

6. The system of claim 5, wherein each of the plurality of switches is a Single-Pole Double-Throw (SPDT) switch; when one of the plurality of AND gates outputs a high voltage level signal, the one of the plurality of switches connected to the one of the plurality of AND gates is electrically connected to the power supply unit; when one of the plurality of AND gates outputs a low voltage level signal, the one of the plurality of switches connected to the one of the plurality of AND gates is grounded.

7. The system of claim 6, wherein the plurality of switches and the plurality of AND gates are arranged in a matrix, and the plurality of loads are arranged in another matrix.

8. The system of claim 1, wherein the micro control unit comprises an inter-integrated circuit (I2C) module connected to the temperature sensor via a serial data (SDA) line and a serial clock (SCL) line; the I2C module is adapted to send a signal reading instruction to the temperature sensor via the SDA line, and to send a clock signal to the temperature sensor via the SCL line.

9. The system of claim 1, wherein the micro control unit comprises a pulse width modulation (PWM) module connected to the fan, the PWM module is adapted to output a PWM signal to the fan to adjust the rotation speed of the fan.

10. The system of claim 1, wherein the micro control unit is adapted to reduce the number of turned-on loads of the plurality of loads and/or increase the rotation speed of the fan when the internal temperature exceeds the predetermined threshold.

11. The system of claim 1, wherein the micro control unit is adapted to increase the number of turned-on loads of the plurality of loads and/or reduce the rotation speed of the fan when the internal temperature is less than or equal to the predetermined threshold.

12. A method for monitoring server simulated loads, the method comprising:
connecting a micro control unit to each of a fan, a load module, and a temperature sensor, wherein the load module comprises a plurality of loads;
housing the fan and the load module in a server chassis;
turning on/off one or more loads of the plurality of loads by the micro control unit;
detecting an internal temperature of the server chassis by the temperature sensor;
determining, by the micro control unit, whether the internal temperature exceeds a predetermined threshold; and
increasing the number of turned-on loads of the plurality of loads and/or reducing a rotation speed of the fan by the micro control unit, when the micro control unit determines that the internal temperature is less than or equal to the predetermined threshold.

13. The method of claim 12, further comprising:
turning on a power supply unit, wherein the power supply unit comprises a power line connected to the load module; and
outputting, by the power supply unit, a voltage signal to the load module via the power line.

14. The method of claim 13, further comprising:
connecting a current monitoring chip to the power line of the power supply unit;
measuring a current flowing through the power line to obtain a current value by the current monitoring chip; and
calculating an output power of the power line by the micro control unit.

15. The method of claim 12, further comprising reducing the number of turned-on loads of the plurality of loads and/or increasing the rotation speed of the fan by the micro control unit, when the micro control unit determines that the internal temperature exceeds the predetermined threshold.

16. The method of claim 12, further comprising producing an alarm signal when the internal temperature exceeds the predetermined threshold.

17. A method for monitoring server simulated loads, the method comprising:
connecting a micro control unit to each of a fan, a load module, and a temperature sensor, wherein the load module comprises a plurality of loads;
housing the fan and the load module in a server chassis;
turning on/off one or more loads of the plurality of loads by the micro control unit;
controlling the fan to run at a constant rotation speed by the micro control unit; detecting an internal temperature of the server chassis by the temperature sensor;
determining, by the micro control unit, whether the internal temperature exceeds a predetermined threshold; and
increasing the number of turned-on loads of the plurality of loads, when the micro control unit determines that the internal temperature is less than or equal to the predetermined threshold.

18. The method of claim 17, further comprising reducing the number of turned-on loads of the plurality of loads by the micro control unit, when the micro control unit determines that the internal temperature exceeds the predetermined threshold.

19. The method of claim 17, further comprising producing an alarm signal when the internal temperature exceeds the predetermined threshold.
